(19) United States
(12) Patent Application Publication
(10) Pub. No.: US 2004/0263635 A1
(43) Pub. Date: Dec. 30, 2004

(54) Digital camera with a function of displaying the degree of hand tremble

(75) Inventors: Takato Katagiri, Ome-shi (JP); Shiro Nagaoka, Ome-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/847,578

(22) Filed: May 18, 2004

(30) Foreign Application Priority Data
Jun. 30, 2003 (JP) 2003-188708

(51) Int. Cl. G03B 17/00

(52) U.S. Cl. 348/208.15; 396/52; 348/208.99

(57) ABSTRACT

An imaging element converts an optical image acquired by the optical system, into an electric signal. A camera-signal processing unit processes the electric signal. From the electric signal, an automatic iris-detecting unit generates iris information representing the brightness of the object. A hand-tremble-degree detecting unit determines whether the hand-tremble information represents a high-degree hand tremble or a low-degree hand tremble, from the iris information generated by the automatic iris-detecting unit and shutter-speed information that sets an exposure time for the imaging element. The detecting unit outputs hand-tremble-degree information that represents a high-degree hand tremble or a low-degree hand tremble. A display control means causes a display unit to display a first mark when the hand-tremble-degree information represents a low-degree hand tremble. When the hand-tremble-degree information represents a high-degree hand tremble, the display control means causes the display unit to display a second mark.

### CROSS-REFERENCE TO RELATED APPLICATIONS

This application is based upon and claims the benefit of priority from prior Japanese Patent Application No. 2003-188708, filed Jun. 30, 2003, the entire contents of which are incorporated herein by reference.

### BACKGROUND OF THE INVENTION

1. Field of the Invention

The present invention relates to a digital camera that has a function of displaying how much it is vibrated as the user's hand that holding it trembles, thereby to enhance the use reliability of the digital camera.

2. Description of the Related Art

Digital cameras have been developed. They can acquire an optical image of an object, generate an electric video signal representing the optical image acquired, convert the video signal to digital data, and store the digital data in a digital recording medium. Of the digital cameras, those that have a high-magnification zoom lens are increasingly demanded. The zoom lens for use on the conventional digital still cameras has a magnification of about 300% at most. Hence, it does matter so much when the user's hand holding the camera trembles.

The tremble of the user's hand holding the camera (hereinafter referred to as “hand tremble”) imposes a prominent influence on the photographing performed by cameras with a high-magnification lens. The influence of hand tremble is conspicuous in the 35-mm film camera if the lens has a focal distance of 50 mm and the exposure time is longer than 1/60 sec. If the lens is replaced by one having twice as high a magnification, the shutter speed should be raised two times. That is the exposure time should be shorted. However, the exposure time cannot be shorted anywhere or at any time. If the ambient light may be insufficient, the exposure time needs to be relatively long; it is undesirable to increase the shutter speed.

Most cameras available at present can operate in the automatic mode. Of the automatic mode items, AE (Automatic Exposure) is important. The exposure is controlled in accordance with some rules. One rule is to set the diaphragm opening at the minimum and the shutter speed is adjusted in a very bright environment. Another rule is to open the diaphragm, set the shutter speed at a small value (to nullify the influence of hand tremble) in a bright environment, and lower the shutter speed when it gets dark. The control of the diaphragm opening has priority over the shutter speed. This is because the focal depth increases (to make it easier to achieve focusing) as the diaphragm opening decreases.

As described above, the exposure time is lengthened (that is, the shutter speed is decreased) if the ambient light is insufficient. In a camera whose lens has a zoom magnification that corresponds to a focal distance f of 50 mm, however, the influence of hand tremble will be prominent if the exposure time 1/60 sec. Namely, the higher the magnification of the lens, the greater the influence of hand tremble will be. In view of this, cameras that generate an alarm when the influence of hand tremble increases have been developed. A camera of this type is disclosed in Jpn. Pat. Appln. KOKAI Publication No. 2002-23243.

Cameras of this type can indeed generate an alarm showing a prominent influence of hand tremble. However, they take no measures to nullify the influence of hand tremble.

### BRIEF SUMMARY OF THE INVENTION

An object of the present invention is to a digital camera that can display the degree of hand tremble and show a method the user may perform to decrease the influence of hand tremble.

According to an aspect of the invention, there is provided a digital camera that has a display and means for classifying a hand-tremble into one of various degrees and for causing the display to display an icon representing the degree of the hand tremble occurring, thereby to advise the user of the camera to take the best possible measure to stabilize the camera.

More precisely, the digital camera comprises: an optical system which acquires an optical image of an object; an imaging element which converts the optical image acquired by the optical system, Into an electric signal; a camera-signal processing unit which processes the electric signal output from the imaging element; an automatic iris-detecting unit for generating iris information representing the brightness of the object, from the electric signal; a hand-tremble-degree detecting unit which determines whether the hand-tremble information represents a high-degree hand tremble or a low-degree hand tremble, from the iris information generated by the automatic iris-detecting unit and shutter-speed information that sets an exposure time for the imaging element, and which outputs hand-tremble-degree information which represents a high-degree hand tremble or a low-degree hand tremble; and display control means for causing the display unit to display a first mark when the hand-tremble-degree information represents a low-degree hand tremble, and display a second mark when the hand-tremble-degree information represents a high-degree hand tremble.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1A is a perspective view of a digital camera seen from the front;

FIG. 1B is a plan view of the mode dial provided on the digital camera shown in FIG. 1A;

FIG. 2 is another plan view of the digital camera seen from the back and somewhat below;

FIG. 3 is a block diagram illustrating the optical section and electric section of the digital camera;

FIGS. 4A to 4C are diagrams explaining a manner in which the camera displays the degree of hand tremble;

FIGS. 5A to 5C are diagrams illustrating another manner in which the camera displays the degree of hand tremble;

FIGS. 6A to 6C are diagrams explaining still another manner in which the camera displays the degree of hand tremble;

FIG. 7 is a graph showing photographing-condition information used to classify the tremble degrees that are observed when the camera performs telephotographing; and

FIG. 8 is a graph showing photographing-condition information used to classify the hand-tremble degrees that are observed when the camera performs wide-angle photographing.

### DETAILED DESCRIPTION OF THE INVENTION

An embodiment of this invention will be described, with reference to the accompanying drawings.

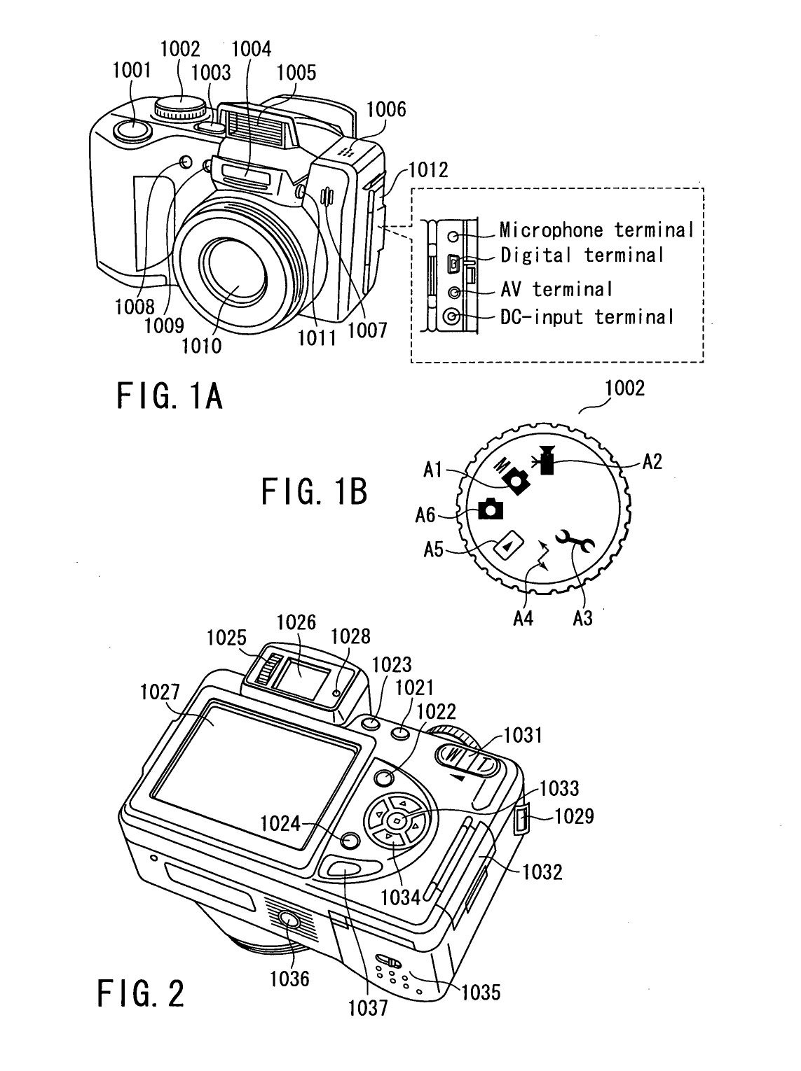

FIG. 1A is a perspective view of a digital camera according to the invention, as seen from the front. FIG. 2 is another plan view of the digital camera seen from the back and somewhat below.

As FIG. 1A shows, the digital camera has a shutter button 1001, a mode dial 1002, and a power switch 1003. The camera also has a display unit 1004 called “front LED.” The display unit 1004 characterizes the digital camera.

The digital camera further has a flash lamp 1005, a speaker 1006, a microphone 1007, a remote-control light-receiving 1008, a flash-light adjusting sensor 1009, a lens 1010, and a flash open button 1011.

The digital camera has a terminal cover 1012. The cover 1012 may be opened to expose an external-microphone terminal, a digital-data output terminal, an AV terminal and a DC-input terminal.

FIG. 1B illustrates the mode dial 1002. The mode dial 1002 has icons printed on it. The icons represent various modes in which the camera can operate. Icon A1 represents the manual-photographing mode (in which the white balance, exposure time, diaphragm opening, shutter speed, and the like can be manually controlled). Icon A2 represents the moving-picture mode (in which a moving picture can be photographed). Icon A3 represents the setup mode (in which the basic setups of the camera, e.g., sound, automatic power-off, customizing, language, video-data output, date and system mode). Icon A4 represents the PC mode (in which video data is input to personal computers). Icon AS represents the reproduction mode, and icon A6 represents the automatic photographing mode. The user may turn the mode dial 1002 to bring one of icons A1 to A6 to a specified position, thereby to select the operating mode that the icon represents.

As FIG. 2 shows, a flash button 1021, a menu button 1022, a self-timer & remote-control button 1023, an erase button 1024, and a visibility-adjusting dial 1025 are arranged on the back of the camera. An EVF 1026 and a liquid display unit 1027 are provided on the back of the camera, too. The liquid display unit 1027 has a screen larger than that of the EVF 1026, which is a liquid crystal display, too. The unit 1027 will be called “LCD screen” so that it may be distinguished from the EVF 1026. A finder LED 1028 is arranged besides the EVF 1026; it may emit light to show that the EVF 1026 is on. A shoulder-strap holder 1029 is secured to one side of the camera.

Moreover, a Tele/Wide button 1031, an OK button 1033 and selection buttons 1034 are provided on the back of the camera. When operated, the Tele/Wide button 1031 set a degree of zooming. When pushed, each selection button 1034 selects a menu items or an image. A guard cover 1032 is laid on the corner defined by the back and one side of the camera. A battery cover 1035 is provided on the bottom of the camera. A screw hole 1036 is cut in the bottom of the camera, to hold the top of a tripod.

A display button 1037 is arranged on the back of the camera. When depressed, the display button 1037 switches the display mode of the EVF 1026 and LCD screen 1027. If pushed rather long, the display button 1037 sets the EVF 1026 and the LCD screen 1027 in sleep mode to save the battery power. The LCD screen 1027 has a size ranging from 1.5 to 2.5 inches, as most display units of this type. By contrast, the EVF 1026 is a small peeping window.

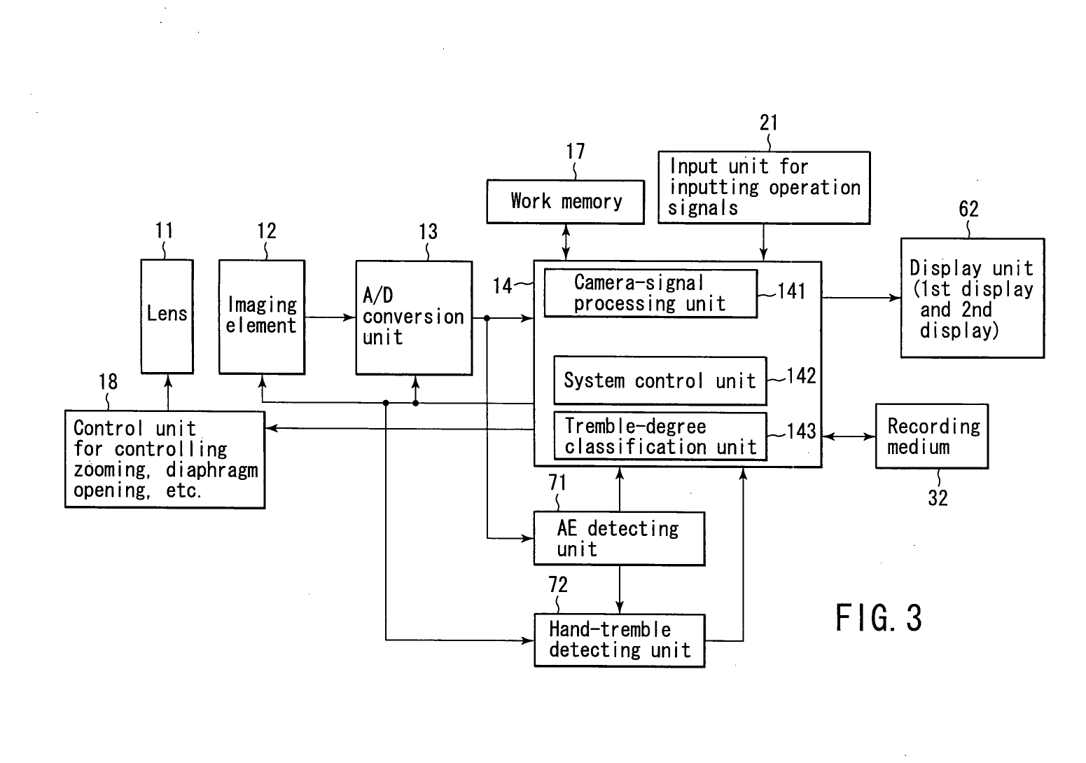

FIG. 3 is a block diagram that illustrates the optical section and electric section of the digital camera. As may be understood from FIG. 3, the light from the object passes through a lens 11 and reaches the image-forming surface of an imaging element 12 (e.g., a CCD element), thus forming an image of the object. The imaging element 12 converts the image into an electric signal. The electric signal is supplied to an analog-to-digital (A/D) conversion unit 13. The unit 13 converts the signal to a digital signal, which is input to a signal-processing unit 14. The unit 14 incorporates a camera-signal processing unit 141. The camera-signal processing unit 141 performs gamma correction, color-signal separation, white-balance control, and the like.

Unless the shutter is operated in normal photographing conditions, the signal-processing unit 14 outputs video data to a display unit 62. The display unit 62 has the EVF (1026 in FIG. 2) and the LCD screen (1027 in FIG. 2). Thus, either the EVF or the LCD screen display the image represented by the video data. (Recall that the LCD screen is larger than the EVF and provide on the back of the camera body.)

When the shutter is operated, an image compression/expansion unit 16 compresses the video data (in JPEG mode, for example). The video data thus compressed is stored into a recording medium 32 under the control of a system control unit 142. The system control unit 142 is provided in the signal-processing unit 14 and has a CPU. The recording medium 32 may be selected from various media. It may be, for example, a semiconductor memory, an optical disk or a magnetic disk.

The video data may be read from the recording medium 32. An image compression/expansion unit (not shown) expands the video data thus read, under the system controller unit. The video data thus expanded is input to the display unit 62. The display unit 62 displays the image represented by the video data.

A work memory 17 is used in the process of editing the video data, forming a thumbnail image or changing the order of images. The work memory 17 can store one frame of video data or frames of video data. The video data stored in the work memory 17 is input, whenever necessary, to the display unit 62 via the memory controller 15. Thus, the user can know how the video data is being edited, looking at the image displayed on the display unit 62.

While the video data is being generated or edited, audio data can be acquired from a microphone (not shown) via an audio interface (not shown, either), under the control of the CPU. The audio data is stored, along with the video data, in the recording medium 32. The audio data is read from the recording medium 32, together with the video data. It is then supplied to a speaker (not shown). Thus, the speaker generates sound from the audio data, and the display unit 62 simultaneously displays the image represented by the video data that is associated with the audio data. According to this invention, the speaker may not generate sound when the user wants to confirm the image only.

In preparation for a photographing operation, the system control unit 142 makes a control unit 18 perform zooming, automatic iris-adjustment (AE), automatic focusing (AF), flash control and the like in accordance with control signals. Further, the system control unit 142 supplies various timing signals, a clock signal and the like to the imaging element 12. The unit 142 supplies various timing signals, a clock signal and the like to the A/D conversion unit 13, too.

As shown in FIG. 3, the digital camera further comprises an AE detecting unit 71 and a hand-tremble detecting unit 72. The AE detecting unit 71 acquires automatic-iris (AE) information from the output of the A/D conversion unit 13. This information represents the AE value that corresponds to the brightness of the object. The AE information is supplied to the system control unit 142 and to the hand-tremble detecting unit 72. The hand-tremble detecting unit 72 receives shutter-speed information, too.

The hand-tremble detecting unit 72 generates hand-tremble information from the AE information and the shutter-speed information. The hand-tremble information is input to a tremble-degree classification unit 143.

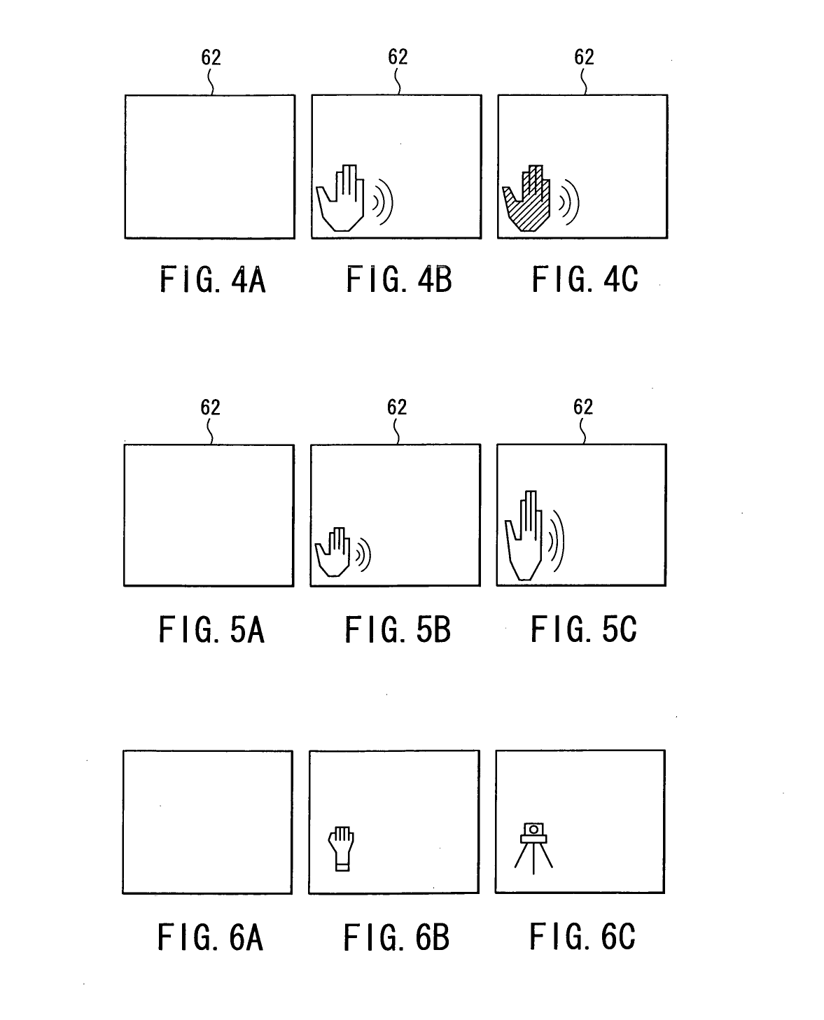

The tremble-degree classification unit 143 classifies hand-tremble information to one of three hand-tremble degrees. The unit 143 generates icon data that represents the hand-tremble degree thus classified. The icon data is supplied to the display unit 62. The display unit 62 display no ions as shown in FIG. 4A or displays an icon as depicted in FIG. 4B or FIG. 4C, indicating one of three hand-tremble degree classified in the unit 143. It is desirable to display the icon on the display the user has selected by operating the display button 1037. That is, the EVF 1026 or the LCD screen 1027, which has been selected, displays the icon.

When the display unit 62 displays no icons, it shows that hand tremble is scarcely occurring. The display unit 62 displays the icon of FIG. 4B that represents a low-degree hand tremble, telling the user to hold his arm steadily to lessen the hand tremble. The display unit 62 displays the ion of FIG. 4C that indicates a high-degree hand tremble, advising the user to place the camera on a table or a tripod. The icon of FIG. 4B is an outline mark (caution), and the icon of FIG. 4C is a red mark (alarm).

Instead of changing the color of the icon to show that the hand tremble changes from the low degree to the high degree, or vice versa, the icon may be changed in size as is illustrated in FIG. 5B and FIG. 5C or in pattern as illustrated in FIG. 6B and FIG. 6C. More precisely, the display unit 62 displays a small hand (caution) as shown in FIG. 5B, which indicates the low degree of hand tremble, or a large hand (alarm) as shown in FIG. 5C, which indicates the high degree of hand tremble. Otherwise, the display unit 62 displays a hand (caution) as shown in FIG. 6B, which indicates the low degree of hand tremble, telling the user to hold his arm steadily to lessen the hand tremble, or a tripod (alarm) as shown in FIG. 6C, which indicates the high degree of hand tremble, advising the user to place the camera on a table or a tripod.

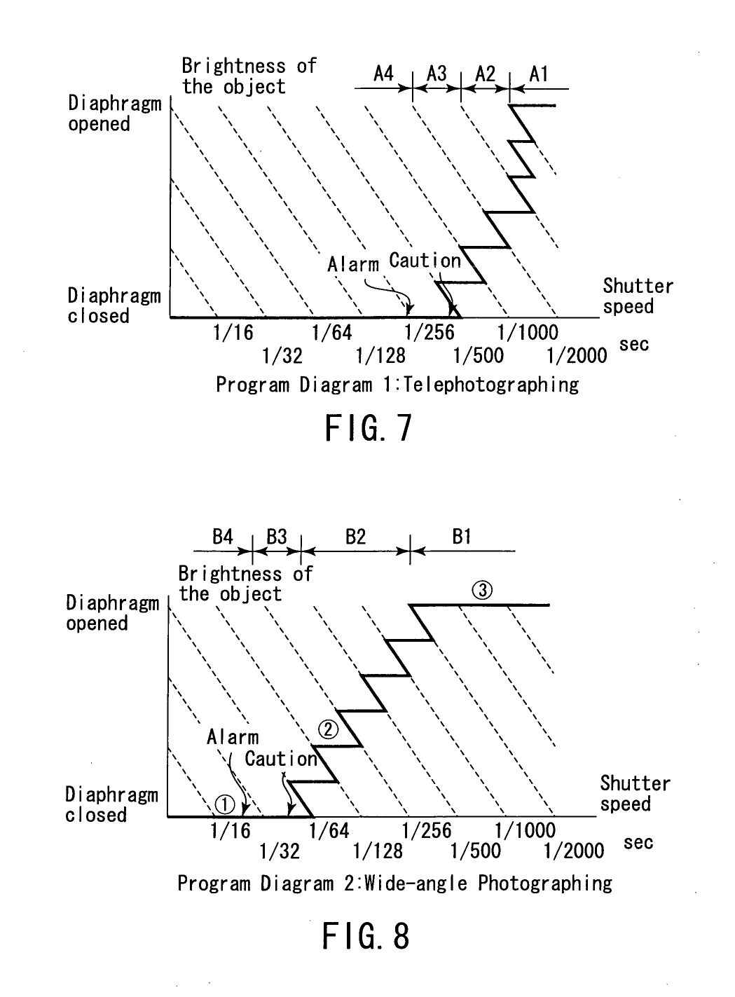

FIG. 7 shows photographing-condition information used to classify the tremble degrees that are observed when the camera performs telephotographing. FIG. 8 shows photographing-condition information used to classify the hand-tremble degrees that are observed when the camera performs wide-angle photographing. In FIGS. 7 and 8, the shutter speed is plotted on the abscissa, and the diaphragm opening on the ordinate. The zigzag line is a program diagram. A caution and an alarm are given at time points that are set in accordance with the shutter speed and diaphragm opening (AE values detected of the object). In FIGS. 7 and 8, each broken line represents the brightness of the object, its lower-left end area and upper-right end area indicating the lowest brightness and the highest brightness, respectively. The information representing the program diagram is stored in the memory that is provided in the system control unit 142.

In region A1 of FIG. 7, no hand tremble may occur and the diaphragm opening is minimal. Thus, the exposure condition time is adjusted in accordance with the shutter speed. In region A2, no hand tremble may occur, and both the diaphragm opening and the shutter speed are adjusted to set an optimal exposure condition. In region A3, a low-degree hand tremble may occur, a caution should be given and the diaphragm opening is maximal. In region A4, a high-degree hand tremble may occur, an alarm should be given and the diaphragm opening is maximal.

In region B1 of FIG. 8, no hand tremble may occur, and the diaphragm opening is minimal. Thus, the exposure condition time is adjusted in accordance with the shutter speed. In region B2, no hand tremble may occur, and both the diaphragm opening and the shutter speed are adjusted to set an optimal exposure condition. In region B3, a low-degree hand tremble may occur, a caution should be given and the diaphragm opening is maximal. In region B4, a high-degree hand tremble may occur, an alarm should be given and the diaphragm opening is maximal.

The information representing the program diagrams of FIGS. 7 and 8 is stored in the system control unit 142. Hence, the hand-tremble detecting unit 72 can determine in which region (shown in FIGS. 7 and 8) the camera is set, from the automatic-iris (AE) information supplied from the AE detecting unit 71, the shutter-speed information setting the exposure time for the imaging element 12, and the photographing mode (telephotographing or wide-angle photographing). In other words, the unit 72 can determine whether no hand tremble, a low-degree hand tremble or a high-degree hand tremble may occur and generates hand-tremble degree information. This information is supplied to the system control unit 142. The system control unit 142 controls the display unit 62 in accordance with the hand-tremble degree information. That is, the unit 142 causes the display unit 62 to display a caution when the camera is set in region A3 or region B3, or to an alarm when the camera is set in region A4 or region B4.

When a high-degree hand tremble is occurring, the digital camera according to this invention displays an alarm, advising the user to take safety measures. Given the alarm, the user may secure the digital camera to the top of a tripod or the like before taking pictures. The camera of the invention does not display a possible hand tremble as the conventional digital cameras.

The present invention is not limited to the embodiment described above. In the embodiment, the display unit can displays a caution or an alarm. Instead, the camera may generate an oral caution and an oral alarm. Alternatively, the camera may give forth two tones of different types, one showing a low-degree hand tremble, and the other showing a high-degree hand tremble. Further, the camera may generate both a visual caution and an oral caution, informing the user of a low-degree hand tremble, and both a visual alarm and an oral alarm, informing the user of a high-degree hand tremble.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital camera having a display unit which displays a degree of a hand tremble, said camera comprising:
an optical system which acquires an optical image of an object;
an imaging element which converts the optical image acquired by the optical system, into an electric signal;
a camera-signal processing unit which processes the electric signal output from the imaging element;
an automatic iris-detecting unit for generating iris information representing the brightness of the object, from the electric signal;
a hand-tremble-degree detecting unit which determines whether the hand-tremble information represents a high-degree hand tremble or a low-degree hand tremble, from the iris information generated by the automatic iris-detecting unit and shutter-speed information that sets an exposure time for the imaging element, and which outputs hand-tremble-degree information which represents a high-degree hand tremble or a low-degree hand tremble; and
display control means for causing the display unit to display a first mark when the hand-tremble-degree information represents a low-degree hand tremble, and display a second mark when the hand-tremble-degree information represents a high-degree hand tremble.

2. The digital camera according to claim 1, wherein the display unit is designed to display the first mark and the second mark in different colors.

3. The digital camera according to claim 1, wherein the display unit is designed to display the first mark and the second mark in different sizes.

4. The digital camera according to claim 1, wherein the hand-tremble-degree detecting unit determines whether the hand-tremble information represents a high-degree hand tremble or a low-degree hand tremble, in accordance with a first rule while the camera remains in a telephotographing mode and in accordance with a second rule while the camera remains in a wide-angle photographing mode.
